(19) United States
(12) Patent Application Publication
(10) Pub. No.: US 2021/0256628 A1
(43) Pub. Date: Aug. 19, 2021

(54) ONLINE TRANSACTION SYSTEM WITH PERSONAL MATCHING

(71) Applicants: Alexander Haden Gellis, Malibu, CA (US); Wendell Brown, Henderson, NV (US)

(72) Inventors: Alexander Haden Gellis, Malibu, CA (US); Wendell Brown, Henderson, NV (US)

(21) Appl. No.: 17/146,254

(22) Filed: Jan. 11, 2021

Related U.S. Application Data
(63) Continuation of application No. 14/519,064, filed on Oct. 20, 2014, now abandoned.
(60) Provisional application No. 61/893,371, filed on Oct. 21, 2013.

(51) Int. Cl. G06Q 50/00

(52) U.S. Cl. CPC G06Q 50/01

(57) ABSTRACT

Methods, systems, computer-readable media, and apparatuses for an online transaction system with personal matching are presented. In some embodiments, a method includes determining a location of a first user and a second user. The method further includes receiving supplemental data associated the first user and supplemental data associated with the second user. The method additionally includes determining a match between a first user and a second user based at least in part on the determined location and the supplemental data. The method further includes presenting a transaction to at least one of the first user or the second user based at least in part on the determined location and the supplemental data. The method also includes facilitating a payment from at least one of the first user or the second user for the transaction.

### CROSS-REFERENCE TO RELATED APPLICATIONS

This is a Continuation Application of U.S. patent application Ser. No. 14/519,064, filed Oct. 20, 2014, which claims the benefit of U.S. Provisional Application No. 61/893,371, filed Oct. 21, 2013, the contents of which are incorporated herein by reference in their entirety.

### BACKGROUND

Aspects of the disclosure relate to a method and system for selecting and completing an online transaction coupled with a personal matching system, and more specifically from a device equipped with location-sensing sensors such as a portable computing device.

Portable-computing devices such as laptops have been supplemented by wearable-computing devices and mobile devices such as mobile phones, tablets, smart watches, etc. Portable computing devices contain a variety of sensors and data input devices. Typical information, hereinafter also referred to as “data,” from portable-computing devices includes; global positioning system (GPS) location, wireless network status, mobile cell phone tower location, device acceleration, audio inputs, video inputs, fingerprint sensors, ambient light inputs, information about other devices associated or nearby the user's portable-computing device, e.g. tethered Bluetooth® devices, and/or like data.

A user of such portable-computing devices may be associated with various online social or other account information, such as Facebook, Twitter, LinkedIn and other similar accounts or networks. Online social account information may include a user's likes and dislikes, e.g. the user's interests. Some online social account information is fed or streamed to a user's portable-computing device as an information feed based on #hashtags, e.g. keywords that relate to the user's interests.

An advertisement, hereinafter also referred to as an “ad,” is used to market and sell a product or service. Typical ads contain primary information in the form of text, images and/or audio information about a product or service. The primary information in the ad may also contain information, such as a toll-free 800 number, a website address, a physical street address, or another means of action that provides a way for the viewer or listener to take an action to either buy the product or obtain more supplemental information related to the ad. Magazine and video ads, roadside billboards, street-level ads, ads on vehicles such as taxis, buses, cars, and the like, contain similar information.

Typical personal matching systems are based on location as derived from GPS latitude/longitude information, wireless network information, mobile cell phone tower information, and/or other similar location data, along with manually entered criteria such as desired age range. However, matches based on location data and manually entered criteria may be inaccurate due to the limited amount of information available to make a good match. Therefore, there exists a need for a personal matching system based on more extensive sources of information in addition to location data and manually entered criteria.

### BRIEF SUMMARY

Certain embodiments are described for an online transaction system with personal matching.

In some embodiments, a method includes determining a location of a first user and a second user. The method further includes receiving supplemental data associated the first user and supplemental data associated with the second user. The method additionally includes determining a match between a first user and a second user based at least in part on the determined location and the supplemental data. The method further includes presenting a transaction to at least one of the first user or the second user based at least in part on the determined location and the supplemental data. The method also includes facilitating a payment from at least one of the first user or the second user for the transaction.

In some embodiments, the method further comprises transmitting a transaction receipt for the transaction to at least one of the first user or the second user.

In some embodiments, the supplemental data is received from a social network.

In some embodiments, determining the location of the first user and the second user comprises determining a location of a first portable computing device associated with the first user and a second portable computing device associated with the second user.

In some embodiments, facilitating the payment from at least one of the first user or the second comprises proportionally dividing a total transaction amount for the transaction into a first transaction amount and a second transaction amount, and facilitating a payment for the first transaction amount from the first user and a payment for the second transaction amount from the second user.

In some embodiments, the supplemental data comprises at least one of user biological data, user social data, user education data, user ethnicity data, user interest data, user relationship data, user religion data, user political data, or user skill data.

In some embodiments, the method also includes presenting, via a user interface to the first user, the supplemental data associated with the second user. In some embodiments, the method further includes presenting, via the user interface to the second user, the supplemental data associated with the first user.

In some embodiments, the method also includes updating a user database based at least in part on completion of the transaction.

In some embodiments, determining the match between the first user and the second user is based at least in part on a match score, wherein the match score is determined based at least in part on a correlation between the supplemental data associated the first user and the supplemental data associated with the second user.

In some embodiments, a server computer includes a processor, and a computer readable medium coupled the processor, the computer readable medium comprising code, executable by the processor, for implementing the above described method.

In some embodiments, one or more non-transitory computer-readable media store computer-executable instructions that, when executed, cause one or more computing devices included in a portable computing device to determine a location of a first user and a second user, receive supplemental data associated the first user and supplemental data associated with the second user, determine a match between a first user and a second user based at least in part on the determined location and the supplemental data, present a transaction to at least one of the first user or the second user based at least in part on the determined location and the supplemental data, and facilitate a payment from at least one of the first user or the second user for the transaction.

### BRIEF DESCRIPTION OF THE DRAWINGS

Aspects of the disclosure are illustrated by way of example. In the accompanying figures, like reference numbers indicate similar elements.

FIG. 1 illustrates a simplified block diagram of a networked information system, in accordance with some embodiments of the present invention.

FIG. 2 is a block diagram of a server computer, according to some embodiments of the present invention.

FIG. 3 depicts a simplified computer-implemented method for matching a plurality of users in a networked information system, in accordance with some embodiments of the present invention.

FIG. 4 depicts a simplified computer-implemented method for matching a plurality of users in a transaction using active selection by user #1, in accordance with some embodiments of the present invention.

FIG. 5 depicts an exemplary simplified portable computing device screen display for a top level navigation screen displayed after the sign up or sign in step depicted in FIG. 3 for navigating the transaction and matching system, in accordance with some embodiments of the present invention.

FIG. 6A depicts an exemplary simplified portable computing device display for displaying and editing “me” match criteria and preference data screen displayed after tapping the “me” row or virtual button depicted in FIG. 5, in accordance with some embodiments of the present invention.

FIG. 6B depicts exemplary simplified portable computing device display screen portions for displaying and editing a first set of data displaying and editing screens displayed after tapping the associated different row or “edit” virtual button depicted in FIG. 6A, in accordance with some embodiments of the invention.

FIG. 6C depicts exemplary simplified portable computing device display screen portions for displaying and editing a second set of data displaying and editing screens displayed after tapping the associated different row or “edit” virtual button depicted in FIG. 6A, in accordance with some embodiments of the present invention.

FIG. 6D depicts exemplary simplified portable computing device display screen portions for displaying and editing a third set of data displaying and editing screens displayed after tapping the associated different row or “edit” virtual button depicted in FIG. 6A, in accordance with some embodiments of the invention.

FIG. 7A depicts an exemplary simplified portable computing device display for displaying and editing “who I'm looking for” match criteria and preference data screen displayed after tapping the “who I'm looking for” row or virtual button depicted in FIG. 5, in accordance with one embodiment of the present invention.

FIG. 7B depicts exemplary simplified portable computing device display screen portions for displaying and editing a first set of data displaying and editing screens displayed after tapping the associated different row or “edit” virtual button depicted in FIG. 7A, in accordance with some embodiments of the invention.

FIG. 7C depicts exemplary simplified portable computing device display screen portions for displaying and editing a second set of data displaying and editing screens displayed after tapping the associated different row or “edit” virtual button depicted in FIG. 7A, in accordance with some embodiments of the invention.

FIG. 8 depicts an exemplary simplified portable computing device screen display for a “recommendations” screen displayed after the system presents a transaction or activity recommendation step depicted in FIG. 3 for agreeing on a match, e.g. user #2, for user #1 to accept or not, in accordance with some embodiments of the present invention

FIG. 9 depicts an exemplary simplified portable computing device display for displaying and purchasing “deals” data screen displayed after tapping a “deals” row or virtual button on a navigations screen such as depicted in FIG. 5, in accordance with one embodiment of the present invention.

FIG. 10 depicts an exemplary simplified portable computing device screen display for a “friendships” screen, in accordance with some embodiments of the present invention.

FIG. 11 depicts an exemplary simplified portable computing device screen display for a “news” screen, in accordance with one embodiment of the present invention.

FIG. 12A depicts an exemplary simplified portable computing device screen display for a “map” screen, in accordance with some embodiments of the present invention.

FIG. 12B depicts an exemplary simplified portable computing device screen display for a “map” screen after tapping on an avatar depicted in FIG. 12A, in accordance with some embodiments of the present invention.

FIG. 13 depicts a simplified block diagram of a computer system that may incorporate embodiments of the present invention

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

According to an embodiment of the present invention, a computer implemented method and system for selecting and completing an online transaction may be coupled with a personal matching system for matching a multitude of users in the transaction, hereinafter also referred to as the “transaction and matching system.” The transaction and matching system matches the multitude of users in accordance with preference and location data associated with each of the multitude of users and presents a transaction to the multitude of users in accordance with the preference and location data. In some embodiments, the transaction may include an online purchase suggested automatically by the transaction and matching system. In some embodiments, the transaction may include an activity suggested automatically by the transaction and matching system.

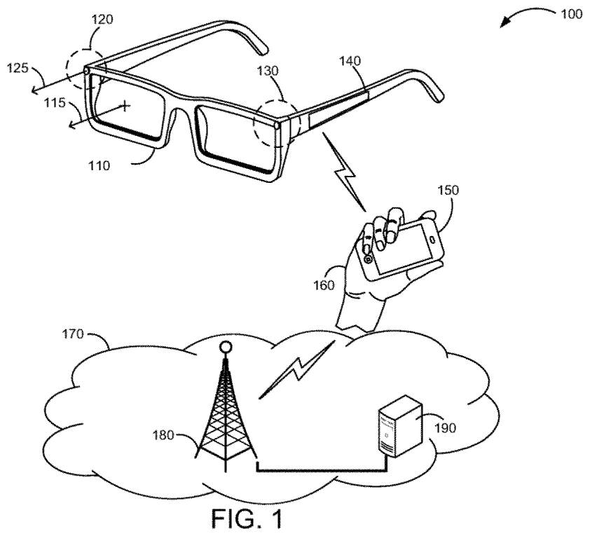

FIG. 1 illustrates a simplified block diagram of a networked information system 100, in accordance with some embodiments of the present invention. FIG. 1 shows a first wearable-computing device 110, a portable-computing device 150, and a cloud network 170. In this example, the first wearable-computing device 110 may include a form factor for eyewear with one or more displays and may include a sensor such as one or more cameras 120, and/or a microphone 130. The camera 120 may include a video and/or a still camera or multiple cameras and one or more optical axis 125 oriented such that the video camera's field of view is aligned with the line of sight 115 of the user. In other words, the camera 120 may see the same image the user sees through the eyewear of first wearable-computing device 110. In some embodiments, the sensor may be powered on continuously or periodically over a predetermined period of time seeing or hearing whatever the user sees and hears in the vicinity of the user.

The first wearable-computing device 110 may further include an electronic circuit 140. The electronic circuit 140 may in-turn include one or more inputs such as a touch sensor or virtual button, a processor, a data store, and a battery. In some embodiments, the electronic circuit 140 may include a wireless radio transceiver. In some embodiments, the wireless radio transceiver may operate on low bandwidth, power saving radio transmission standards such as Bluetooth®, 6LoWPAN®, ZigBee®, DASH7®, Z-Wave®, MiWi®, or OSION®. In some embodiments, the wireless radio transceiver may operate on WiFi®, or cellular radio transmission standards. The first wearable-computing device 110 may be able to project images received by electronic circuit 140 to the user wearing first wearable-computing device 110 through the lenses of the eyewear such that the projected image is seen by the user superimposed over the real image as viewed by the user. Therefore, the resulting information transmitted from the data relevance engine may be visually displayed in the user's field of view on the first wearable-computing device 110.

In some embodiments, electronic circuit 140 may further include an audio output device, such as a speaker or bone transducer. Therefore, the resulting information transmitted from the data relevance engine may be audibly played to the user via the audio output device on first wearable-computing device 110. In some embodiments, electronic circuit 140 may further include GPS, cellular location, and/or orientation circuitry, which may respectively determine the location and/or height on the earth and the orientation at that location of first wearable-computing device 110. In other words, orientation circuitry may provide to first wearable-computing device 110 the direction video camera 120 and the user are viewing, for example, compass or azimuth and altitude angles relative to the user. In some embodiments, electronic circuit 140 may further include a gravitational sensor and/or an accelerometer, which may provide a velocity information and/or an acceleration information for first wearable-computing device 110.

In some embodiments, the portable-computing device 150 wirelessly tethered to the first wearable-computing device represented in FIG. 1, in accordance with some embodiments of the present invention. FIG. 1 shows an example where portable-computing device 150 is a smart phone, however, portable-computing device 150 may be any portable computing device such as a laptop, mini, tablet, or pad, which may or may not include a wireless radio transceiver that may link or tether portable-computing device 150 to the first wearable-computing device 110 on user 160. In some embodiments, portable-computing device 150 may be tethered to first wearable-computing device 110 via a wire and a wired communication system connecting first wearable-computing device 110 to portable-computing device 150. In some embodiments, location, orientation, gravimetric and/or acceleration sensors may be included in portable-computing device 150 or distributed between first wearable-computing device 110 and portable-computing device 150 in any combination. Portable-computing device 150 may further include a cellular radio transceiver or WiFi® radio transceiver that may link portable-computing device 150 to the world-wide-web or cloud network 170.

The world-wide-web or cloud network 170 may be linked to the first wearable-computing device 110. A base station 180 may send or receive cellular or WiFi® radio transmissions to or from the portable-computing device 150, respectively. The base station 180 may be coupled to one or more server 190 computing devices. In some embodiments, a multitude of servers may be located in different locations or in multiple clouds. In another embodiment, the first wearable-computing device 110 may include a cellular radio transceiver or WiFi® radio transceiver directly providing the link to the world-wide-web or cloud network 170 without the portable-computing device 150 serving as the intermediary communications link.

In some embodiments, the user communicates inputs and instructions to the transaction and matching system via an app executing computer code running in the portable computing device 150. In some embodiments, the computer code for the app may be downloaded from a website in the cloud network 170. In some embodiments, the transaction and matching engine may execute computer code running in server 190.

In some embodiments, the first wearable-computing device 110 may be optional in the networked information system 100 and the networked information system 100 may simply include the cloud network 170 and the portable-computing device 150.

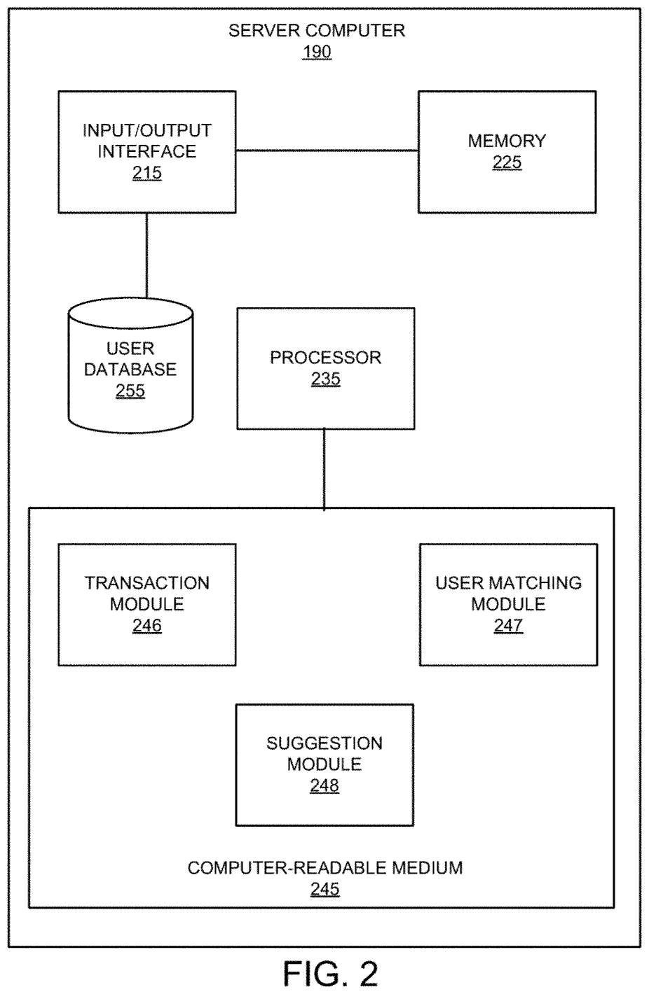

FIG. 2 is a block diagram of a server computer 190, according to some embodiments of the present invention. Server computer 190 may include an input/output interface 215, a memory 225, a processor 235, and a computer-readable medium 245. In some embodiments, the server computer 190 may reside within the cloud network 170 (FIG. 1).

The input/output (I/O) interface 215 may be configured to receive and transmit data. For example, the I/O interface 215 may transmit and receive data to and from the portable-computing device 150 (FIG. 1), via the cloud network 170 (FIG. 1). The I/O interface 215 may accept input from an input device such as, but not limited to, a keyboard, keypad, or mouse. Further, the I/O interface 215 may display output on a display device.

Memory 225 may be any magnetic, electronic, or optical memory. It can be appreciated that memory 225 may include any number of memory modules, that may comprise any suitable volatile or non-volatile memory devices. An example of memory 225 may be dynamic random access memory (DRAM).

Processor 235 may be any suitable processor operable to carry out instructions on the server computer 300. The processor 330 is coupled to other units of the server computer 205 including input/output interface 215, memory 225, and computer-readable medium 245.

Computer-readable medium 245 may be any magnetic, electronic, optical, or other computer-readable storage medium. Computer-readable storage medium 245 may include transaction module 246, user matching module 247, and suggestion module 248. Computer-readable storage medium 245 may comprise any combination of volatile and/or non-volatile memory such as, for example, buffer memory, RAM, DRAM, ROM, flash, or any other suitable memory device, alone or in combination with other data storage devices.

User matching module 247 can be configured to, when executed by processor 235, match two or more users in accordance with preference and location data associated with each of the users. The preference and location data associated with each of the users may be stored in user database 255. The user matching module 247 may, when executed by processor 235, analyze the preference and location data (e.g., supplemental data from a social network) associated with each of the users and match users having similar preference and/or location data. The matching may be performed using a matching algorithm. For example, two users that both share interest in action movies and reside in San Francisco, CA may be matched with one another. The user(s) may be notified of a match via an application running on the users' individual portable-computing devices 150. In some embodiments, the match may be based at least in part on a match score. The match score may be determined based at least in part on a correlation between the preference and location data associated the first user and the preference and location data associated with the second user.

Suggestion module 248 can be configured to, when executed by processor 235, suggest one or more products and/or activities to the two or more users matched by the user matching module 247. The suggested one or more products and/or activities may also be based on preference and location data associated with each of the users may be stored in user database 255. Using the example above, the suggestion module 248 may determine that movie tickets for the latest action movie “Die Hard 10” should be suggested to the users. In some embodiments, the suggestion module 248 may interface with a database internal to the server computer 190 (not shown) or hosted on a separate server and/or network (not shown). The database may include a list of potential activities and/or products available for user suggestion. The database may be updated at any time to accurately reflect activities and/or products from vendors, merchants, and or partners participating with the networked information system 100. The user(s) may be notified of a suggestion via an application running on the users' individual portable-computing devices 150.

Transaction module 246 may be configured to, when executed by processor 235, facilitate a transaction between one or more users and a vendor, merchant, or partner participating with the networked information system 100. The transaction may be facilitated either directly between the user(s) and the vendor, merchant, or partner participating with the networked information system 100, or indirectly between the user(s) and the vendor, merchant, or partner participating with the networked information system 100 via the server computer 190. The transaction may be facilitated by transaction module 246 after an activity and/or product is suggested by suggestion module 248 and a user(s) has indicated his/her intent to purchase the suggested activity and/or product. In some embodiments, the transaction module 246 may interface with one or more payment processing entities to facilitate the transaction. The transaction module 246 may also, when executed by processor 235, facilitate the transaction such that the operator of the server computer 190 may receive a percentage of the transaction amount associated with the activity and/or product purchased by the user(s). In some embodiments, the transaction module 246, when executed by processor 235, may be able to facilitate a split payment between two or more users that agree to purchase the activity and/or product. The user(s) may complete the transaction via an application running on the users' individual portable-computing devices 150.

It can be appreciated that in some embodiments the server computer 190 may reside within the cloud network 170 (FIG. 1), while in other embodiments the server computer 190 may reside external to the cloud network 170 (FIG. 1).

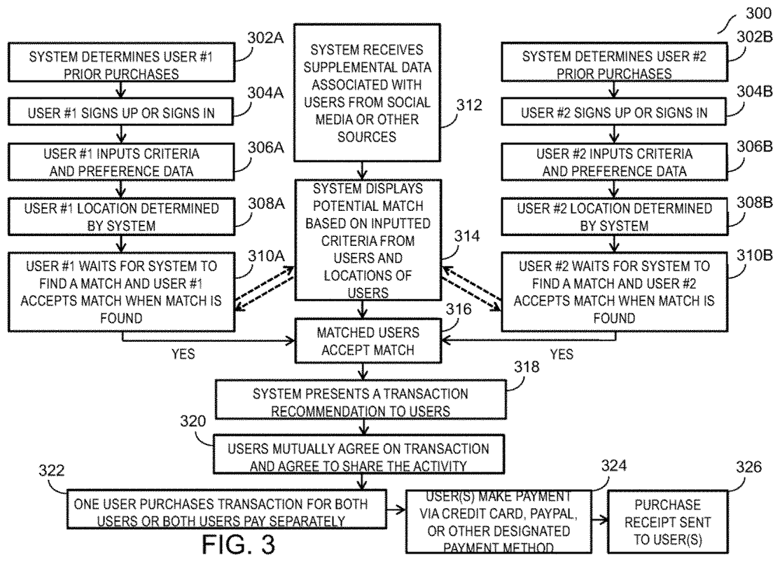

FIG. 3 depicts a simplified computer-implemented method 300 for matching a plurality of users in a networked information system, in accordance with some embodiments of the present invention. As described above, the networked information system may match two or more users together and suggest activities and/or products to the matched users based on user location and preferences.

The networked information system may determine prior purchases for one of the multitude of users, e.g. user #1 (block 302A). Simultaneously, the networked information system may determine prior purchases for another one of the multitude of users, e.g. user #2 (block 302B). In some embodiments, the networked information system may determine the prior purchases for the users by accessing a user database configured to store various information pertaining to the users, including but not limited to, prior purchase history of the users.

Either user #1 or user #2 may then sign into the system (blocks 304A and 304B, respectively). The user(s) may sign into the system via a web portal or a mobile application running on each user's respective portable-computing device. If the user is not already registered with the system, the user may be guided through a sign up process to register with the system.

Each of the users registered with the networked information system may input criteria and preference data (blocks 306A and 306B). The criteria and preference data may include, but is not limited to, likes and dislikes, interests, biological data, social data, education data, ethnicity data, etc. If the user has already previously registered with the system, the user may not need to resubmit criteria and preference data. Optionally, if the user feels that his/her preferences have changed, the user may update previously entered criteria and preference data.

In blocks 308A and 308B, the networked information system may determine a location of each user using traditional location determination techniques (e.g., GPS location, Wi-Fi positioning system, etc.). The location of the users may be determined by determining the location of the users' respective portable-computing devices. The portable-computing devices may be equipped with hardware to facilitate the location determination (e.g., GPS chip, Wi-Fi chip, etc.). In some embodiments, the portable-computing devices may periodically provide location information to the networked information system. In some embodiments, the portable-computing devices may provide location information to the networked information system upon receiving a location request from the networked information system.

In blocks 310A and 310B, two or more users may be matched with each other. In this example, user #1 may be matched with user #2, and vice versa. The match may be based on a matching algorithm that analyzes the criteria and preference data of the various users within the networked information system. Each of the users may be notified of the match on either a web portal associated with the networked information system or a mobile application running on their respective portable-computing devices. The users may be provided with information pertaining to the match (e.g., who the matched user is) and with an option to accept or reject the match.

If both the users are agreeable to the match, both users may accept the matching using the web portal associated with the networked information system or a mobile application running on their respective portable-computing devices (block 316).

Once the match has been made and accepted by the users, the networked information system may provide a transaction recommendation to the users (block 318). The transaction recommendation may be based on the criteria and preference data associated with each user. For example, if both user #1 and user #2 indicate that they are interested in basketball, the networked information system may provide a transaction recommendation for tickets to a local basketball game. In some embodiments, the transaction recommendation may also be based on previously completed transactions by the user(s) and, in some embodiments, a rating given by the user(s) to the previously completed transactions. The transaction recommendation may be provided to the user(s) via either a web portal associated with the networked information system or a mobile application running on their respective portable-computing devices. In addition, the transaction recommendation may also include the transaction amount and an option to split the transaction among the users.

In block 320, the users may mutually agree on the transaction and agree to share the activity. For example, user #1 and user #2 may both accept the transaction recommendation for tickets to the local basketball game, and agree to split the transaction cost among the two of them. The users may indicate their intent to agree to the transaction and, in some cases, the transaction split by interacting with either a web portal associated with the networked information system or a mobile application running on the users' respective portable-computing devices.

In block 322, 323, and 324, the networked information system may facilitate payment for the transaction accepted by the users. In block 322, either one of the users may pay for the transaction or the transaction may be split among the users. The networked information system may facilitate a request for payment to the user(s) and the user(s) may pay for the transaction via credit card, PayPal, or any other designated payment method (block 324). Accordingly, the networked information system may interface with one or more third-party payment processing entities in order to facilitate the payment for the transaction. Once the payment is complete, a purchase receipt may be sent by the networked information system to the user(s) (block 326). Additionally, the networked information system may provide the users with further information on redeeming the purchased item and/or activity from the transaction.

It is understood that user #1 is associated with a portable computing device of user #1, such that unless described to the contrary, the transaction and matching system interacts automatically with the portable computing device of user #1 in accordance with instructions or actions from user #1. Thus, it is understood that when the figures depict user #1 taking an action it is the same as the portable computing device of user #1 performing that action unless described otherwise (such as when user #1 enters input data or instructions). Accordingly, the transaction and matching system maintains a list of online transactions that may be automatically reported by the portable computing device of user #1, and that may be filtered according to various criteria then ranked according to user #1's likely interest and coupled with a personal matching system. The transaction and matching system correlates or associates location information data of the portable computing device of user #1 with transaction data such that previous transaction and their associated location data are stored in a database of the transaction and matching system. The user signs up or signs in 102 for the service.

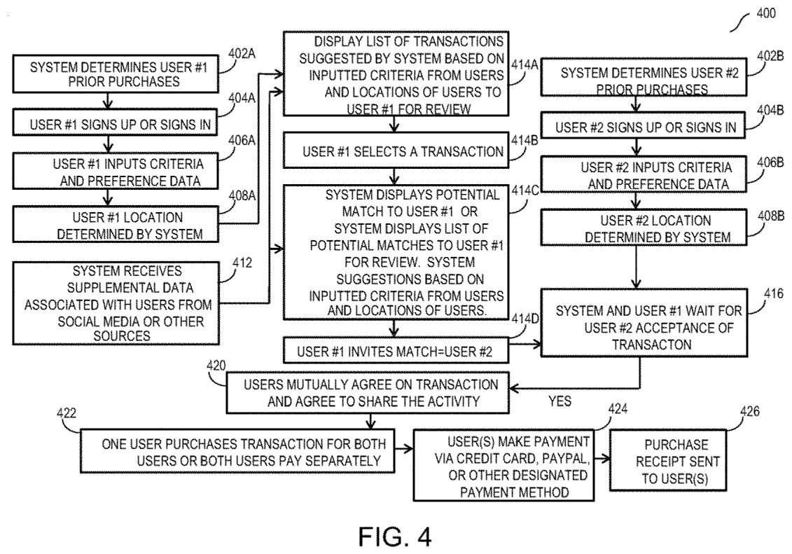

FIG. 4 depicts a simplified computer-implemented method 400 for matching a plurality of users in a transaction using active selection by user #1, in accordance with some embodiments of the present invention. Computer-implemented method 400 may include the same features as computer-implemented method 300 depicted in FIG. 3, with the following exceptions. After determining (block 408A and 408B) the location of user #1, primary and/or secondary data inputs may be correlated and ranked automatically in real-time by the transaction and matching engine (e.g., transaction module 246 and user matching module 274). The transaction and matching engine may then determine a multitude of ranked suggested transactions in accordance with the correlated and ranked primary and secondary information inputs (e.g., inputted criteria from users and locations of users). The transaction and matching system may then display (block 414A) a ranked list of the multitude of suggested transactions (e.g., purchases or activities) on the portable computing device associated with user #1 for user #1 to review. Then, user #1 may select one of the multitude of ranked suggested transactions (block 414B)

Primary and/or secondary data inputs may be correlated and ranked automatically in real-time by the transaction and matching engine to determine or calculate a ranked list of best matches. The transaction and matching system may then displays on the personal computing device associated with user #1 one or more potential matches in real time in accordance with highest rank order analogous to block 314 depicted in FIG. 1 (block 414C).

Referring to FIG. 4, alternatively, the transaction and matching engine may determine a multitude of ranked suggested matches in accordance with the correlated and ranked primary and secondary information inputs (e.g., inputted criteria from users and locations of users). The transaction and matching system may then display a ranked list of the multitude of suggested matches (e.g., user #2 and other users determined to be matched to user #1) on the portable computing device associated with user #1 for user #1 to review (block 414C). Then, user #1 may select or invite at least one of the multitude of ranked suggested matches (e.g., user #2, or user #2 and other users determined to be matched to user #1) (block 414D). After user #1 selects or invites (block 414D) at least one of the multitude of ranked suggested matches, the transaction and matching system and user #1 may wait for user #2, or user #2 and other invited users, to accept the transaction (block 416).

In some embodiments, a user may select or invite one or more of the user's already known multitude of friends to join the user in the transaction. In some embodiments, a user may meet a multitude of new friends through the transaction and matching system, who may join the user in the transaction.

In some embodiments, a multitude of friends may be invited to join the user in the transaction, then the multitude of friends who are “first to accept,” up to a predefined maximum number of attendees, may then be confirmed to join in the transaction. In some embodiments, the multitude of users who accept to participate in the transaction are collected by the transaction and matching system. Then, the final attendee list may be determined through the transaction and matching system, which may randomly pick the final participants from among all those who confirmed interest by accepting.

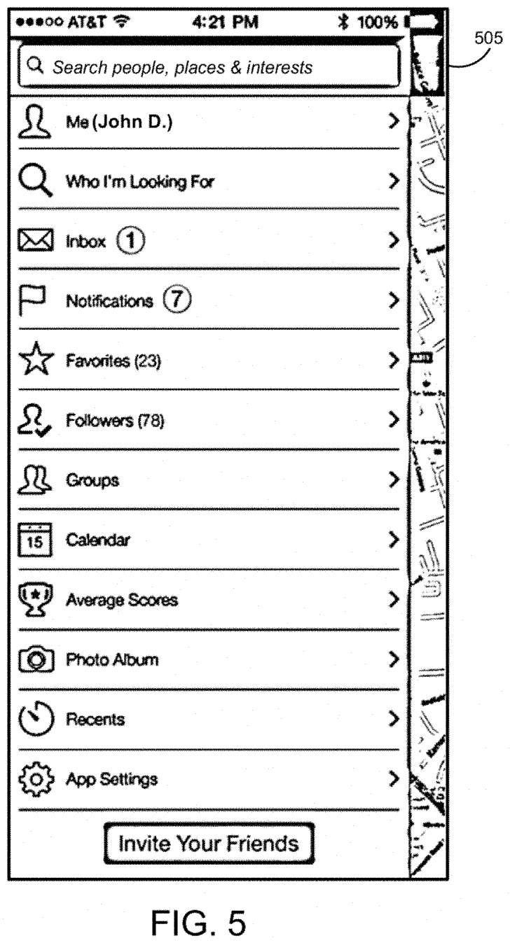

FIG. 5 depicts an exemplary simplified portable computing device screen display for a top level navigation screen 505 displayed after the sign up or sign in step 304A and 304B depicted in FIG. 3 for navigating the transaction and matching system, in accordance with some embodiments of the present invention. Top level navigation screen 505 may include virtual buttons or rows that when tapped navigate the transaction and matching system to review/edit match criteria and preference data for user #1, further identified as “me” followed by the user's name in parenthesis “(John D.).” Top level navigation screen 505 may further include virtual buttons or rows that when tapped navigate the transaction and matching system to review/edit match criteria and preference data for another user, i.e., user #2 who is being looked for by user #1 and further identified as “who I'm looking for.” Top level navigation screen 505 may further include virtual buttons or rows that when tapped navigate the transaction and matching system to receive “inbox” or messages, “notifications”, “favorites”, “followers”, “groups”, “calendar”, “average score”, “photo album”, “recents” matches, “news” (not shown), “deals” (not shown), and “application settings.”

Referring again to FIG. 3, after user #1 signs in to or signs up (block 304A) for the transaction and matching system, new users may input match criteria and preference data (block 306A) and returning users may edit match criteria and preference data entered in or sent to the transaction and matching system's database from the personal computing device. Match criteria and preference data may include data entered by user #1 that describes personal characteristics of user #1 and/or that describes personal characteristics of another user, i.e., a user #2 who user #1 is looking for or wants to meet. In some embodiments, the match criteria and preference data may be uploaded to the transaction and matching system's database in real time or at predetermined intervals or trigger conditions. In some embodiments, the uploading trigger condition may be when the transaction and matching system at the personal computing device detects that a match criteria and preference data has been edited or newly entered.

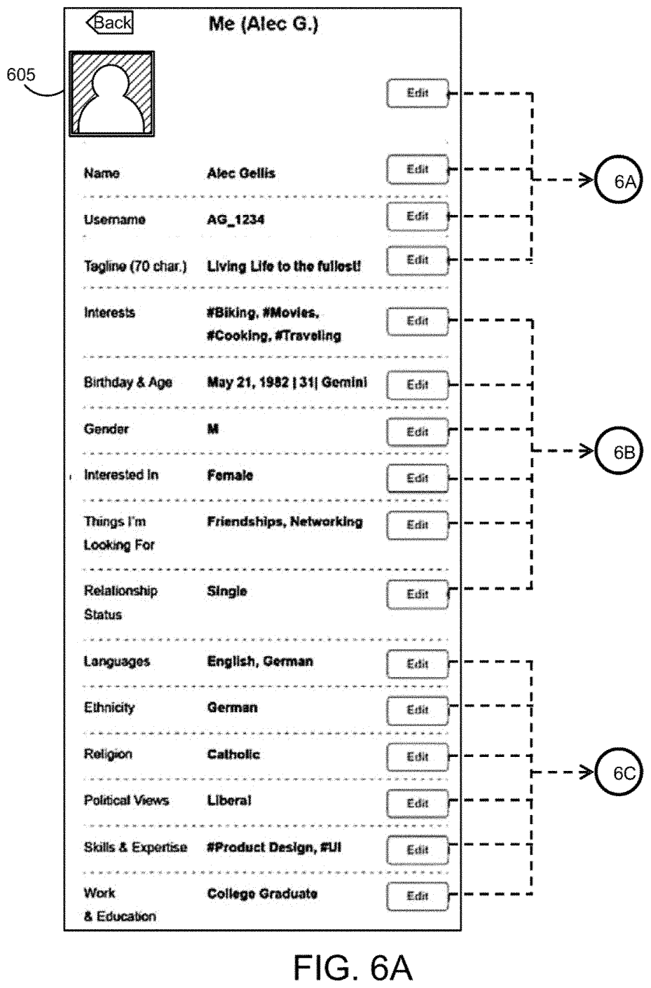

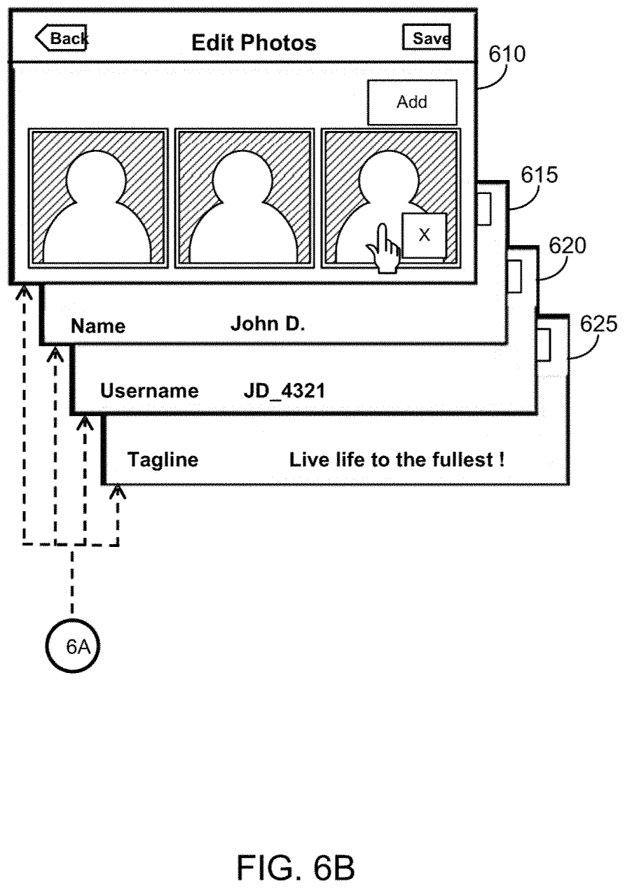

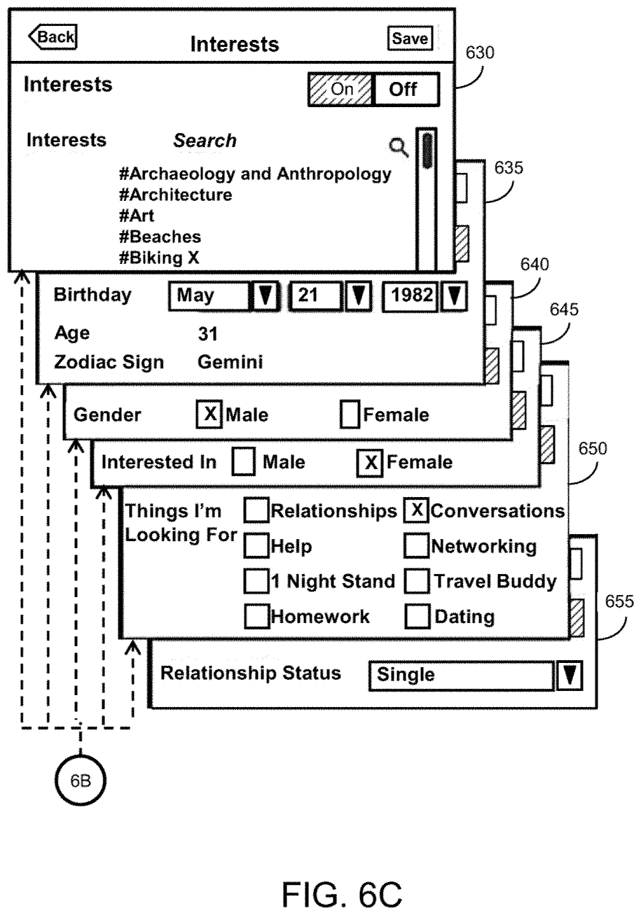

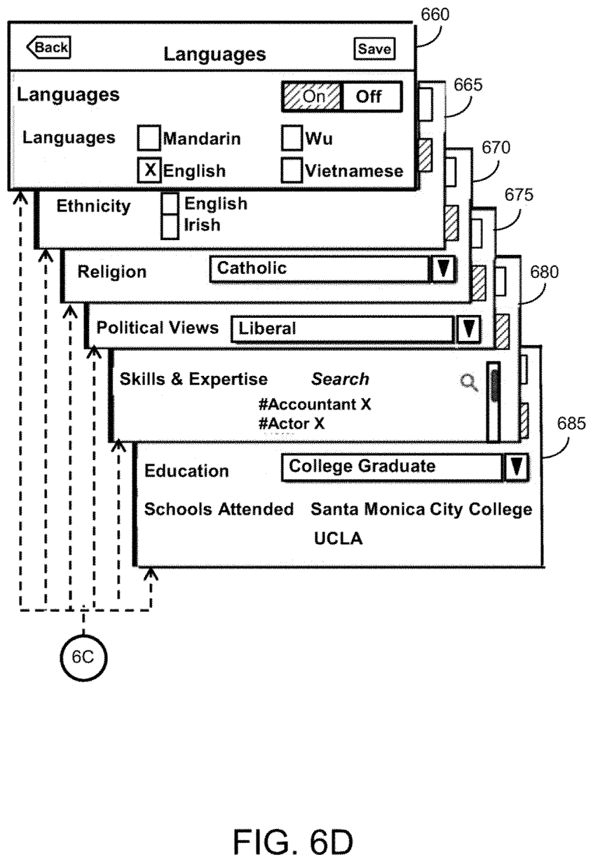

FIG. 6A depicts an exemplary simplified portable computing device display for displaying and editing “me” match criteria and preference data screen 605 displayed after tapping the “me” row or virtual button depicted in FIG. 5, in accordance with some embodiments of the present invention. Displaying and editing match criteria and preference data screen 605 may include a multitude of rows displaying personal characteristics data associated with user #1 that is manually entered by user #1 to describe himself or herself and uploaded automatically to the transaction and matching system. The manually entered personal characteristics data associated with user #1 may be described in greater detail below in three sets 6A, 6B, 6C of data displaying and editing screens.

Each screen of data displaying and editing screens may include a “save” virtual button to save and report the personal characteristics data associated with user #1 to the transaction and matching system. Each screen of sets 6B, 6C of data displaying and editing screens may further include an “on/off” virtual button to enable/disable the associated different match criteria and preference data type and report to the transaction and matching system whether the associated match criteria and preference data type is to be used for match correlation or not. Each screen of data displaying and editing screens further includes a “return” virtual button to again display the displaying and editing “me” match criteria and preference data screen 605.

FIG. 6B depicts exemplary simplified portable computing device display screen portions 610, 615, 620, 625 for displaying and editing a first set 6A of data displaying and editing screens displayed after tapping the associated different row or “edit” virtual button depicted in FIG. 6A, in accordance with some embodiments of the invention. The personal characteristics data associated with user #1 may include data displayed and edited in the “edit photos” screen 610, which depicts a multitude of possible photos of user #1 available for selection, which were previously uploaded to the transaction and matching system. In one embodiment, user #1 may select a photo to be used by the transaction and matching system in real time according to location and/or activity preferences. For example, a picture of user #1 in casual cloths may be selected when informal activities such as meeting another user in a coffee shop are desired, while a picture in sportswear may be selected for meeting another user at a sports activity. A photo is associated with user #1 according to which photo has been tapped to toggle that photo to indicate it is selected. Photos may be added by tapping an “add” virtual button.

The personal characteristics data associated with user #1 may include data displayed and edited in the edit “name” screen 615, which depicts a name associated with user #1, which may be available to other users through the transaction and matching system. The “name” may be edited via an alphanumeric entry field (not shown). The personal characteristics data associated with user #1 may include data displayed and edited in the “username” screen 620, which depicts a name associated with user #1, which may not be available to other users through the transaction and matching system but may identify user #1 during log in. In some embodiments, the “username” may be edited via an alphanumeric entry field during getting an account. The personal characteristics data associated with user #1 may include data displayed and edited in the “tagline” screen 625, which depicts a tagline associated with user #1, which may be available to other users through the transaction and matching system. For example, the tagline “Live life to the fullest!” may be displayed to briefly describe user #1 to other users as explained below. In one embodiment the “tagline” may be edited via an alphanumeric entry field (not shown).

FIG. 6C depicts exemplary simplified portable computing device display screen portions 630, 635, 640, 645, 650, 655 for displaying and editing a second set 6B of data displaying and editing screens displayed after tapping the associated different row or “edit” virtual button depicted in FIG. 6A, in accordance with some embodiments of the present invention. The personal characteristics data associated with user #1 may include data displayed and edited in the “interests” screen 630, which depicts a scrollable list of a multitude of possible subjects of interest available for selection by tapping one or more subjects to activate. In one embodiment, activated subjects may be displayed by an “X” appended to the subject after selection. The personal characteristics data associated with user #1 may include data displayed and edited in the “birthday and age” screen 635, which depicts a pull down list for birthday “month”, “date” and “year”. In one embodiment the “age” and “horoscope sign” may be automatically determined by the transaction and matching system.

The personal characteristics data associated with user #1 may include data displayed and edited in the “gender” screen 640, which depicts a multitude of possible genders of user #1, and an “interested in” screen 645, which depicts a multitude of possible genders user #1 desires to be matched with. The personal characteristics data associated with user #1 may include data displayed and edited in the “things I'm looking for” screen 650, which may include a multitude of personal relationship categories such as, for example, “relationships”, “conversations”, “help” “networking”, “1 night stand”, “travel buddy”, “homework”, “dating”, and the like. Associated different toggle on/off virtual buttons may be used for “gender”, “interested in”, and “things I'm looking for” selection in “gender” screen 440, “interested in” screen 645, and “things I'm looking for” screen 650, respectively. The personal characteristics data associated with user #1 may include data displayed and edited in the “relationship status” screen 655, which depicts a pull down list for present “relationship status” such as “single”, “divorced”, “dating”, “married”, and the like.

FIG. 6D depicts exemplary simplified portable computing device display screen portions for displaying and editing a third set 6C of data displaying and editing screens displayed after tapping the associated different row or “edit” virtual button depicted in FIG. 6A, in accordance with some embodiments of the invention. The personal characteristics data associated with user #1 may include data displayed and edited in the “languages” screen 660 and “ethnicity” screen 665, which list a multitude of languages and ethnicities supported for correlation by the transaction and matching system. A language or ethnicity is associated with user #1 according to which associated different virtual buttons have been tapped to toggle the type of language or type of ethnicity on. The personal characteristics data associated with user #1 may include data displayed and edited in the “religion” screen 670 and “political views” screen 675, which include pull down menus for selecting the type of religion and political view by tapping the selected religion and political view to “on.”

The personal characteristics data associated with user #1 may include data displayed and edited in the “skills & expertise” screen 680, which depicts a scrollable list of a multitude of possible work related or professional skills available for selection by tapping one or more skills to activate. In some embodiments, activated skills may be displayed by an “X” in a checkbox virtual button that toggles on/off appended to the skills after selection. The personal characteristics data associated with user #1 may include data displayed and edited in the “education” screen 685, which includes a pull down menus for selecting the education level achieved by user #1 by selecting the education level and a multitude of alphanumeric field to enter a multitude of “schools attended”.

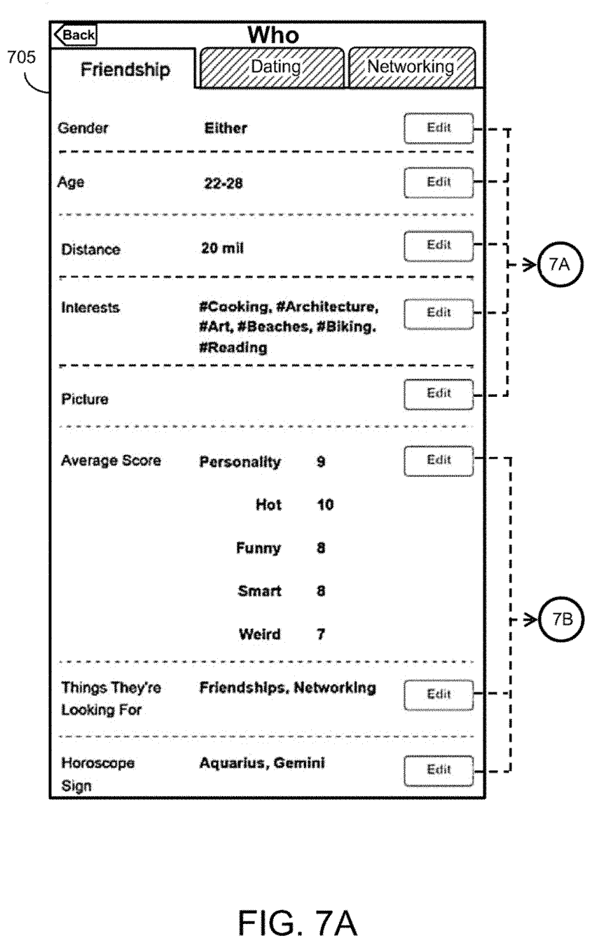

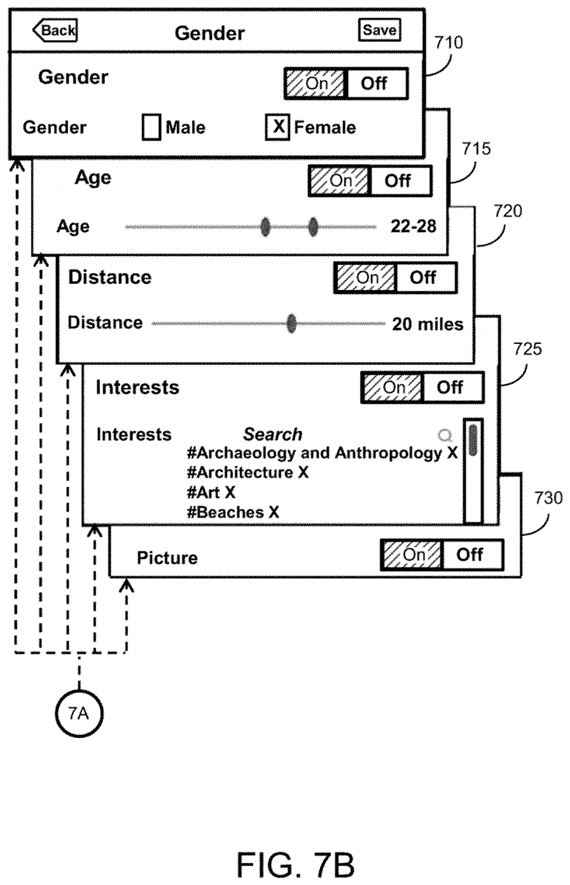

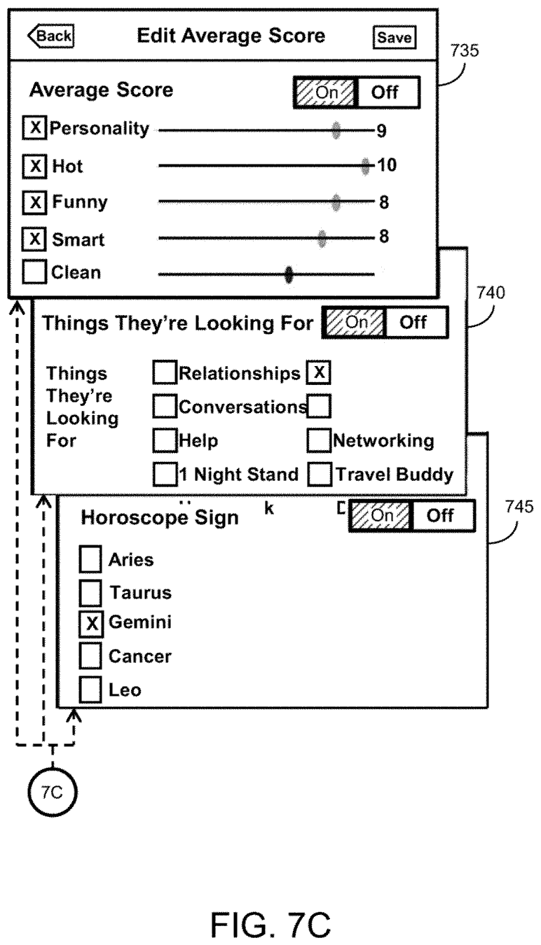

FIG. 7A depicts an exemplary simplified portable computing device display for displaying and editing “who I'm looking for” match criteria and preference data screen 705 displayed after tapping the “who I'm looking for” row or virtual button depicted in FIG. 5, in accordance with one embodiment of the present invention. Displaying and editing “who I'm looking for” match criteria and preference data screen 705 includes a multitude of rows displaying personal characteristics data associated with user #1 that is manually entered by user #1 to describe personal characteristics of another user that user #1 believes he or she wants to meet that may be uploaded automatically to the transaction and matching system. The manually entered personal characteristics data associated with user #1 about who user #1 is looking for will be described in greater detail below in two sets 7A, 7B of who user #1 is looking for data displaying and editing screens.

Each screen of who user #1 is looking for data displaying and editing screens may include a “save” virtual button to save and report the personal characteristics data associated with user #1 to the transaction and matching system. Each screen of sets 5A, 5B of who user #1 is looking for data displaying and editing screens further includes an “on/off” virtual button to enable/disable the associated different match criteria and preference data type and report to the transaction and matching system whether the associated match criteria and preference data type is to be used for match correlation or not. Each screen of who user #1 is looking for data displaying and editing screens further includes a “return” virtual button to again display the displaying and editing “who I'm looking for” match criteria and preference data screen 705.

FIG. 7B depicts exemplary simplified portable computing device display screen portions 710, 715, 720, 725, 730 for displaying and editing a first set 7A of data displaying and editing screens displayed after tapping the associated different row or “edit” virtual button depicted in FIG. 7A, in accordance with some embodiments of the invention. The personal characteristics data associated with who user #1 is looking for may include data displayed and edited in a “gender” screen 710, which may include analogous features as “gender” screen 640 described in reference to FIG. 6C.

Referring to FIG. 7B, the personal characteristics data associated with who user #1 is looking for may include data displayed and edited in a “age” screen 715, which includes a bar with two movable virtual sliders associated with an upper and lower age range respectively, e.g., 22-28 years of age. A virtual slider may be an icon or feature displayed on a touch sensitive screen that responds to being dragged or moved by a user's finger or stylus. The personal characteristics data associated with who user #1 is looking for may include data displayed and edited in the “distance” screen 720, which may include a bar with one movable virtual slider associated with a maximum distance between user #1 and user #2 for the transaction and matching system to correlate in selecting a match. The personal characteristics data associated with who user #1 is looking for may include a feature preference displayed and edited in “picture” screen 730. “Picture” screen 730 may include the on/off virtual button to indicate to the transaction and matching system to apply negative weighting during match correlation to other users who have not submitted a photo of themselves in their personal characteristics data when this picture feature is enabled. The personal characteristics data associated with who user #1 is looking for may include data displayed and edited in the “interests” screen 725, which may include analogous features as “interests” screen 630 described in reference to FIG. 6C.

FIG. 7C depicts exemplary simplified portable computing device display screen portions 735, 740, 745 for displaying and editing a second set 7B of data displaying and editing screens displayed after tapping the associated different row or “edit” virtual button depicted in FIG. 7A, in accordance with some embodiments of the invention. The personal characteristics data associated with who user #1 is looking for may include data displayed and edited in the “average score” screen 735, which may include a multitude of score bars, each with a different movable virtual slider associated with a multitude of different personal characteristic scores. In some embodiments, the multitude of different personal characteristic scores may include “personality”, “hot”, “funny”, “smart”, “clean”, and the like. In some embodiments, the multitude of different personal characteristic scores may each be associated with a different value on a scale of integer numbers ranging from a lowest score of zero to a highest score of 10 set by the relative position of the slider button on the associate score bar. “Average score” screen 735 may include a different checkbox virtual button associated with each one of the score bars to enable/disable the associated different personal characteristic score and report to the transaction and matching system whether the associated personal characteristic score is to be used for match correlation or not.

The personal characteristics data associated with who user #1 is looking for may include data displayed and edited in the horoscope sign screen 745, which may include a multitude of signs of the zodiac such as, for example, “Aries”, “Taurus”, “Gemini”, “Cancer”, “Leo”, and the like. Associated different checkbox virtual buttons may be used for selecting one or more of the signs of the zodiac in horoscope sign screen 745. The personal characteristics data associated with who user #1 is looking for may include data displayed and edited in the “things they're looking for” screen 735, which may include features analogous to “things I'm looking for” screen 650 described in reference to FIG. 6C.

Referring to FIG. 3, after user #1 inputs 306A match criteria and preference data, the transaction and matching system may determine 608A the location of user #1's portable computing device via one or more sensors in the portable computing device. The portable-computing device may, in real-time, sense primary information about the environment in the local vicinity, line-of-sight, and/or hearing distance adjacent the portable-computing device via the one or more sensors. At least one sensor on the portable-computing device senses primary information such as device acceleration, motion, audio, video, fingerprint, heart rate, breathing rate, retina scan, and/or other biometric sensors, ambient light, near-field communication, wireless network status, infrared, ultrasonic, gyroscopic, orientation, and/or the like. The portable-computing device may include a multitude of such sensors to sense information associated with the user's environment in real-time.

Further, a sensor may be associated with the portable-computing device through another portable device or second portable-computing device that are different than but tethered wirelessly or by wire to a first portable-computing device in various combinations. In other words, a sensor need not be on the user's first portable-computing device but may be associated with the user's first portable-computing device. For example, an audio microphone may be located on an earpiece wirelessly connected to a first portable-computing device, such as a smart-phone having a video camera sensor. A bicycle speedometer type portable-computing device on a bicycle may be further added to the first portable-computing device's sensor network. A multitude of information inputs each from a different one of a multitude of sensors in the portable-computing device may be transmitted in real-time as an information stream to the transaction and matching system.

Any number of sensors may be tethered in a local network to provide data of interest associated with the user's environment or where the user is located, such as on a bicycle, automobile, plane, or other transportation vehicle. Accordingly, sensors are not associated with keyboard keys or keyboard icons, nor is real time sensor data the same as data that is input via keyboard keys or keyboard icons, such as the match criteria and preference data primary information input by user #1 at step 306A. In some embodiments, data from a user's portable-computing device's body motion sensors are used to correlate and weight location data inputs. In some embodiments, data from a user's wearable-computing device, which indicates the user's location, such as GPS information, cell phone tower, and/or the like, is sent to the to the transaction and matching system and used to gather, correlate, weight and then rank the output data.

Primary information may be directly sensed from the local environment in real-time, such as an ad that is sensed by visual, audio, or electronic means by the portable-computing device or the user. Further, primary information may be data requested by the user through the portable-computing device such as a feed, tweet, web page, e-mail, or the like. In contrast, secondary, hereinafter also referred to as “supplemental,” information is information that is not primary information, as will be discussed below.

The primary sensor information is transmitted from the portable-computing device to a computing device in the transaction and matching system called a transaction and matching engine via cable, radio, infrared, or other internet network link. In one embodiment, data from one or more real-time sensors is passively collected, e.g. an audio or video sensor data may be continuously transmitted in real-time, for a predetermined period of time. The predetermined period of time may be chosen by the user via controls in the portable-computing device. In some embodiments, primary sensor information is transmitted upon request or demand, or upon a timed predetermined sequence. In some embodiments, primary sensor information is transmitted continuously in time as an information stream, the sensor information following the changes in the environment as the user moves through that environment, not only as geographic location changes but further including changes in the users orientation, such as what the user's wearable-computing device may be seeing or hearing in real time.

In some embodiments, the transaction and matching engine is a computing device located in the internet cloud, which may provide a critical advantage of not adding additional computational or data storage burdens on the portable-computing device that increases battery life and performance of the portable-computing device. In some embodiments, the transaction and matching engine may be located in the portable- computing device. In some embodiments, one portion of the transaction and matching engine may be located in the internet cloud (e.g., within server 190), while another portion of the transaction and matching engine may be located in the portable-computing device 150. In some embodiments, the transaction and matching engine may perform calculations in one or more computing devices, e.g. servers “in the cloud”, with such computing devices connected to a user's portable, mobile, or wearable-computing-device via a wireless connection, such as a WiFi, mobile data network, Bluetooth, or similar network, or via a wired connection, such as Ethernet.

In some embodiments, the primary information is transmitted from the portable-computing device to the transaction and matching engine directly. In some embodiments, the primary information is transmitted from the portable-computing device to the transaction and matching engine indirectly, e.g. from a wearable-computing device tethered to the portable-computing device, such as a smart phone.

In some embodiments, the primary information may include global positioning system (GPS) location for the portable-computing device. The GPS location may be transmitted from the portable-computing device to the transaction and matching engine.

In some embodiments, the primary information may include time and/or date information for the portable-computing device. The time and/or date information may be transmitted from the portable-computing device to the transaction and matching engine. In some embodiments, the time and/or date information may be available to the transaction and matching engine, which then correlates or time and/or date stamps the received primary information accordingly.

In some embodiments, the primary information may include information associated with the portable-computing device, such as contacts, prior, e.g. historical location data of the device, email addresses, account, serial, identification, model, firmware, web address, stored photo or video, historical browser information such as prior purchases and/or payments, and/or the like. The information associated with the portable-computing device may be transmitted from the portable-computing device to the transaction and matching engine when the system stores user #1's prior purchases and associated locations (block 302A).

Referring to FIG. 3, in some embodiments, after determining the location of user #1 (block 308A), the portable computing device associated with user #1 waits for the transaction (block 310A) and matching system to find a match and then for user #1 to signify acceptance of the suggested match. Analogous to the operations 302A, 304A, 306A, 308A, 310A, performed and described above in relation to user #1 or the portable computing device associated with user #1, method 300 may include similar operations for other users of the transaction and matching system, such as depicted in steps 302B, 304B, 306B, 308B, 310B, respectively performed and described above in relation to user #2 or the portable computing device associated with user #2.

In some embodiments, secondary or supplemental information may be associated with a user interest from the user's social network in the cloud, such as likes, dislikes, social graphs, social graph elements, friends, thumbs up, thumbs down, email addresses, stored photo or video, product or service reviews, #hashtags, tweets and/or the like. The information associated with the user's social network, such as Facebook, may be received from the cloud by the transaction and matching engine. In some embodiments, the user may be associated with the portable-computing device.

In some embodiments, the user may not be associated with the portable-computing device. For example, the user may be a social network friend of or someone who recommends the user who is associated with the portable-computing device. Then the supplemental data may include recommendations, preferences, or interests of a user who is not associated with the portable-computing device (i.e., user #1) but may still be associated through the social network with the user who is associated with the portable-computing device. Thereby, the transaction and matching engine may have access to a multitude of user interest data from users who may share similar interests as the user associated with the portable-computing device. In some embodiments, other sensors in the user's nearby location, such as sensors associated with other nearby users, fixed sensors, and/or the like may be used as primary real-time inputs. In some embodiments, data in a user's social graph, for example such as the Facebook social graph, or other similar user data, such as the user's friends or friend's likes, may be used to correlate and weight data inputs.

In some embodiments, secondary information may be associated with advertiser information or ads. The information associated with the ads may be received from the cloud or from other sources by the transaction and matching engine (block 312).

In some embodiments, primary and/or secondary information may be associated with external information sources, which are linked and/or accessed by the transaction and matching engine (block 312). External information sources may include any kind of information source or service that may push, feed, transmit, or be accessible as information to the portable-computing device not included in the information input embodiments already described above. Examples of external information sources include Yelp, Groupon, broadcasting networks, such as NBC Sports or National Public Radio, financial information services, email services, text messaging services, geographical map database services, weather reporting and/or prediction, historical information such as purchase, payment, or credit history, other websites and/or the like.

Primary and/or secondary data inputs described above may be correlated and ranked automatically in real-time by the transaction and matching engine to determine a user preference and display on the personal computing device associated with user #1 one or more potential matches in real time in accordance with highest rank order (block 314). In other words, the transaction and matching engine may correlate the primary information, e.g. from the real-time sensors on the portable-computing device and the user's match criteria and preference data, with secondary information, e.g. data from social media networks, associated with a user interest, to form a correlated data.

The transaction and matching engine may then correlate and rank one of the multitude of users as a match with one or more other ones of the multitude of users, producing data that is assigned a numerical weighting, RankWeight, with the purpose of providing at least one of the multitude of users a suggested match or a list of relative ranked potential matches. The RankWeight may be static or dynamic, and may be different for different types of sensors, users, or other factors. The ranked order of the list of potential matches is associated with the correlated real time data. In some embodiments, the location data for the multitude of users is determined to generate a location distance between potential matches. However, this location distance is not the only input that determines rankings in the potential match output results, but merely one of many factors used to determine ranking of input data at any given time. In some embodiments, a portion of the potential matches may be displayed on the user's portable-computing device. In some embodiments, all of the potential matches may be displayed on the user's portable-computing device.

Because the primary and/or secondary data that is included in the correlated data is associated with user interest data, the ranked order may therefore be associated with the user's interests. Further, because the primary data may include current sensor data associated with the local environment adjacent the portable-computing device, and thereby with the user, the ranked order may be associated with activities or locations the portable-computing device is encountering in real time, without requiring much, if any, input by the user. The use of the real time sensor data associated with the immediate environment of the portable-computing device provides a critical advantage that improves the relevance of the ranking over the relevance that can be obtained by previously known techniques. In some embodiments, the one or more potential matches may be streamed continuously or periodically. In some embodiments, the one or more potential matches may not be streamed. In some embodiments, the one or more potential matches may be displayed on the personal computing device of a user via an “alert” or a “notification.”

In some embodiments, the transaction and matching engine may make its determination of the rank order automatically, without active user input, using passively collected data from primary and/or secondary data inputs that are associated with the user's interests. In some embodiments, the transaction and matching engine may make its determination of the rank order semi-automatically, with some active user input during a learning period for the transaction and matching engine or during occasional subsequent times when the user wants the output of the transaction and matching engine to be adjusted or changed, for example when the user's interest changes.

In some embodiments, personal matches may be done by the transaction and matching system in a recurrent, series of batch processes. In some embodiments, personal matches may be done by the transaction and matching system in a real-time or almost-real-time process.

In some embodiments, data from one or more real-time location sensors may be detected, processed, then correlated with the user's non-sensor-data (such as data from a user's Facebook social graph), input into the real-time or batch transaction and matching engine, which may output match and transaction suggestions displayed on a user's portable computing device, other display, or otherwise output to the user.

In some embodiments, data from one or more real-time location sensors may be passively collected, detected, processed, then correlated with the user's non-sensor-data (such as data from a user's Facebook Social graph), input into the real-time transaction and matching engine, which may output match and transaction suggestions continuously updated and displayed on a user's portable computing device, other display, or otherwise output to the user.

In some embodiments, data from one or more real-time sensors is upon request or demand, or upon a timed sequence, collected, detected, processed, then correlated with the user's non-sensor-data (such as data from a user's Facebook social graph), input into the real-time transaction and matching engine, which may output match and transaction suggestions continuously updated and displayed on a user's portable computing device, other display, or otherwise output to the user.

Referring to FIG. 3, after user #1 accepts the suggested match, e.g. user #2, and user #2 accepts the suggested match, e.g. user #1, then the matched users accept the match (block 316). Then the transaction and matching system may present a transaction or activity recommendation to the users, e.g. user #1 and user #2 (block 318). The users may mutually agree on the transaction and agree to share the activity (block 320). Alternatively one of the users may reject the match at step 310A, 310B or transaction at block 320 suggested by the transaction and matching system, in which case the transaction and matching system suggests another different match user or transaction recommendation having the next highest ranking RankWeight.

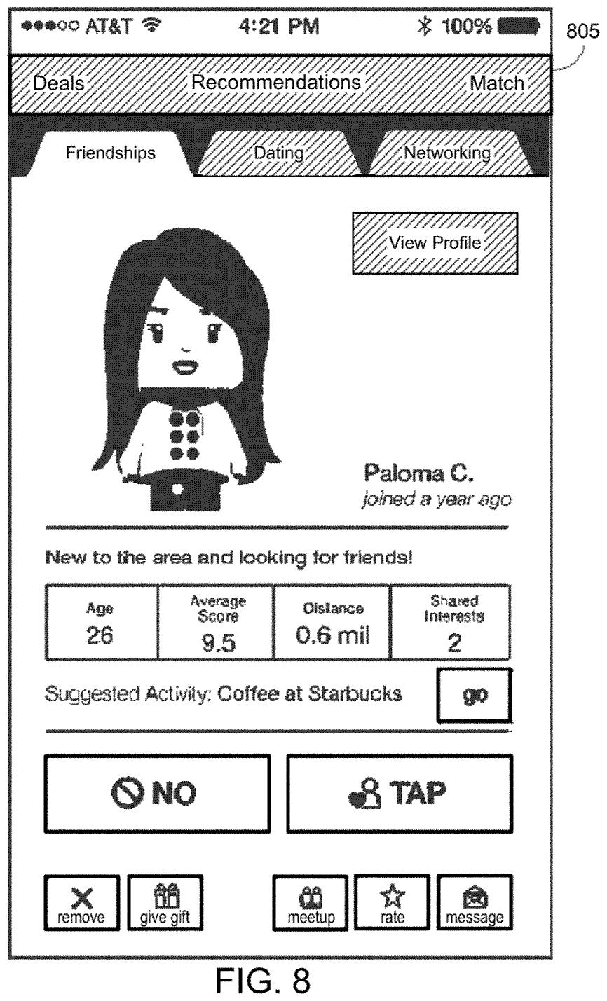

FIG. 8 depicts an exemplary simplified portable computing device screen display for a “recommendations” screen 805 displayed after the system presents (block 318) a transaction or activity recommendation step depicted in FIG. 3 for agreeing on a match, e.g. user #2, for user #1 to accept or not, in accordance with some embodiments of the present invention. In some embodiments, “recommendations” screen 805 may include virtual tabs to display recommendations for a match and/or transaction in accordance with activated “things I'm looking for” categories activated by the user of the portable computing device receiving the recommendations. For example the virtual tabs may include “friendships,” “dating,” “networking,” and/or the like. In some embodiments, “recommendations” screen 805 may display a different recommendation for a match and/or a transaction in accordance with which tab is selected for viewing by the user of the portable computing device receiving the recommendations.

In some embodiments, “recommendations” screen 805 may include a multitude of personal characteristics information about user #2 (for user #1 to accept), such as for example: a photo, a “name”, a time since first joining the transaction and matching system, a tagline, an “age”, an “average score”, a real time “distance”, a number of “shared interests”, a “suggested activity” (e.g. coffee at Starbucks).

“Recommendations” screen 805 may include the following multitude of virtual buttons to enable the transaction and matching system take associated different actions when user #1 activates at least one of the multitude of virtual buttons by tapping. The multitude of virtual buttons may include a “view profile” virtual button to enable user #1 see more of the personal characteristics of user #2, a “go” virtual button to signal the acceptance of the suggested match and activity, a “no” virtual button to turn down the suggested match and activity, and a “tap” virtual button to let user #2 know that user #1 exists. The multitude of virtual buttons may further include: a “message” virtual button to send a message to user #2, a “rate” virtual button to enable user #1 rate and submit a score for user #2, a “remove” virtual button to remove user #2 from the match considerations for user #1, a “give gift” virtual button to connect user #1 with online service providers to order a gift for user #2, and a “meet-up” virtual button to provide a way for user #1 to suggest a meeting place to user #2.

Referring to FIG. 3, after users have mutually agreed on the transaction, and agree to share the activity at step 320, at least one of the multitude of matched users may purchase (block 322) the transaction for the multitude of matched users or the multitude of matched users may purchase the activity separately. Accordingly, at least one of the matched users may make payment (block 324)to purchase the transaction online via a credit card, PayPal, or other online payment method. Then a purchase receipt may be sent electronically to the at least one of the matched users making payment (block 326).

In some embodiments, a multitude of advertisements that are relevant/related in real-time to the primary and/or secondary data inputs and thus selected by the transaction and matching system to match the user's real-time interests may be presented on the user's portable computing device. In some embodiments, at least one advertisement, which is deemed to relate in real-time to at least one of the data input sources, may be presented to the user via the user's portable computing device. In some embodiments, at least one merchant offer, for example such as a local daily deal, which may be deemed to relate to at least one of the data input sources, may be presented on the user's portable computing device. In some embodiments, a ranked list of potential “daily deals” or “local deals” may be presented to the user's portable computing device either passively, e.g. without active user action, or upon demand of the user.

In some embodiments, the information presented on the user's portable computing device may include an actionable link. For example, the actionable link may direct the user's browser to a website that may initiate a purchase of a service or product. In one embodiment, the user may select one of the items in the multitude of items included in the resulting information.

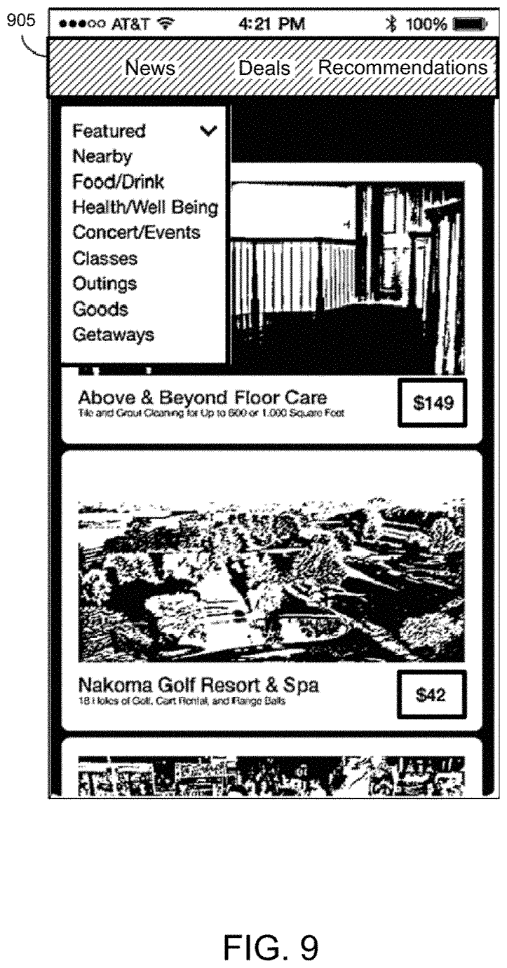

FIG. 9 depicts an exemplary simplified portable computing device display for displaying and purchasing “deals” data screen 905 displayed after tapping a “deals” row or virtual button on a navigations screen such as depicted in FIG. 5, in accordance with one embodiment of the present invention. Displaying and purchasing “deals” data screen 905 may include a deals categories navigation window that may list a multitude of deal categories. The user of the portable computing device may tap a line item on the deals categories navigation window to select the display of an associated multitude of scrollable ad windows, wherein each ad window may be associated with the selected deal category. Further, each ad window in the multitude of scrollable ad windows may include a price and purchase virtual button, which if tapped by the user may purchases the ad item through the transaction and matching system or launch the user's browser to a website associated with that item through which the user may purchase the item.

For example, the deal categories may include “featured”, “nearby”, “food/drink”, “health/well-being”, “concerts/events”, “classes”, “outings”, “goods”, “getaways”, and the like. In some embodiments, the deal category “featured” may include a listing of featured daily deals. In some embodiments, the deal category “nearby” may include a listing of deals ranked according to the user's interests and distance criteria selected in the personal characteristics data associated with the user. In some embodiments, the deal category “food/drink” may include a listing of nearby food and drink deals. In one embodiment, the deal category “health/well-being” may include a listing of nearby health and well-being deals. In some embodiments, the deal category “concerts/events” may include a listing of nearby concert and event deals.

In some embodiments, the deal category “classes” may include a listing of nearby class deals ranked according to the user's interests and distance criteria selected in the personal characteristics data associated with the user. In some embodiments, the deal category “outings” may include a listing of nearby outing deals ranked according to the user's interests and distance criteria selected in the personal characteristics data associated with the user. In some embodiments, the deal category “goods” may include a listing of “goods” deals ranked according to the user's interests criteria selected in the personal characteristics data associated with the user. In some embodiments, the deal category “getaways” may include a listing of getaway deals ranked according to the user's profile.

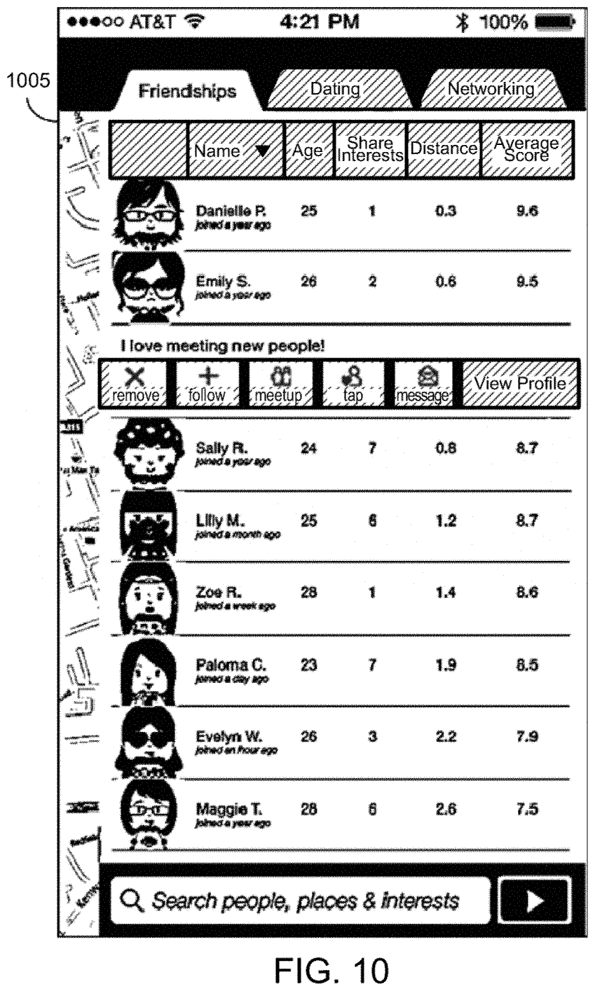

FIG. 10 depicts an exemplary simplified portable computing device screen display for a “friendships” screen 1005, in accordance with some embodiments of the present invention. “Friendships” screen 1005 may include a list of matched users in accordance with input criteria for who user #1 wants as a friend. The list of matched users may include a table of matched users with columns including the “name”, time since joining the transaction and matching system, “age”, number of “shared interests”, real time “distance” from user #1, and “average score” and rows including the associated data for each of the different multitude of ranked matches. In some embodiments, the table of matched users displays matched users may be ranked in order by “average score”, with users having highest “average score” on top and the rest of the users listed by row in descending rank order. In some embodiments, tapping on a row of the table of matched users may display a tagline for the selected potential match and a row of virtual buttons. The row of active virtual buttons may include a “remove” virtual button, a “follow” virtual button, a “meet-up” virtual button, a “tap” virtual button, a “message” virtual button, and a “view profile” virtual button analogous to the virtual buttons described in reference to FIG. 8. In some embodiments, “friendships” screen 1005 may provide one example for displaying a way for user #1 to select a group of matched friends to participate in a transaction.

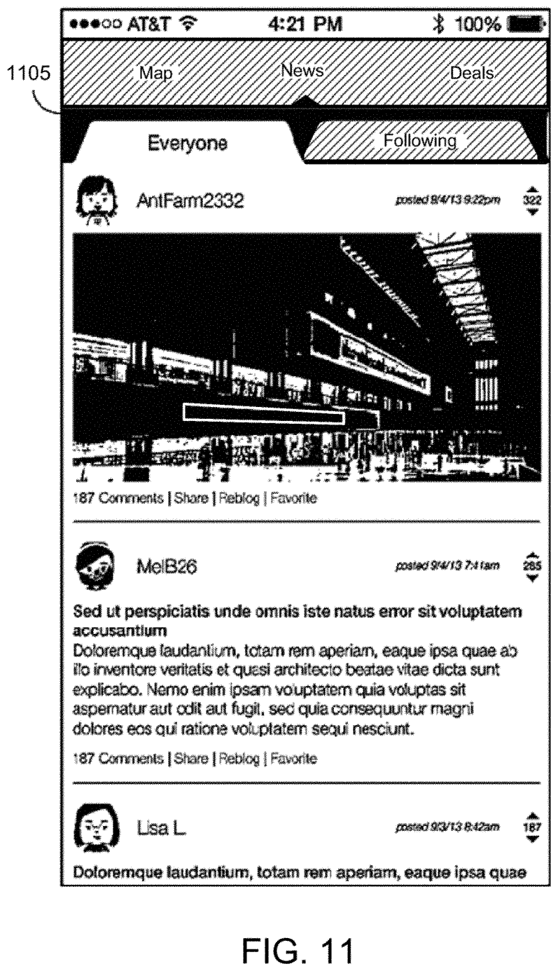

FIG. 11 depicts an exemplary simplified portable computing device screen display for a “news” screen 1105, in accordance with one embodiment of the present invention. “News” screen 1105 includes a multitude of scrollable blog windows where different users may post news displayed in two display category tabs including “everyone” and “following”. In some embodiments, selecting the “everyone” tab displays a list of news posted by all users. In some embodiments, selecting the “following” tab displays a list of news posted by the multitude of users that user #1 follows.

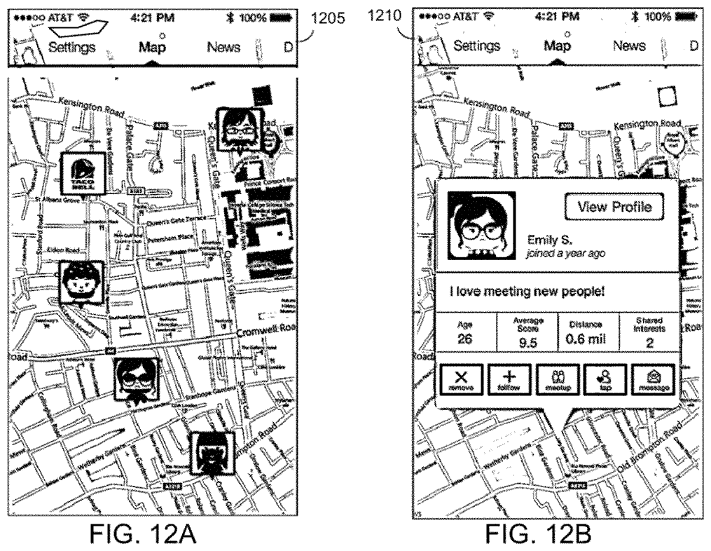

FIG. 12A depicts an exemplary simplified portable computing device screen display for a “map” screen 1205, in accordance with some embodiments of the present invention. “Map” screen 1205 may include a map of the vicinity where user #1 is located, avatars of users, and icons of transaction providers (e.g., sellers and ad sponsors) that may be located on the map in real-time according to primary and secondary inputs to the transaction and matching engine. Tapping on an icon displays a deal description.

FIG. 12B depicts an exemplary simplified portable computing device screen display for a “map” screen after tapping on an avatar 1210 depicted in FIG. 12A, in accordance with some embodiments of the present invention. Tapping on an avatar brings up a window smaller than but including similar features as “recommendations” screen 805 depicted in FIG. 8 with the exception of not displaying the “no”, “go”, “give gift”, and “rate” virtual buttons. Further, “map” screen 1210 may include a “follow” virtual button that when tapped by user #1 instructs the transaction and matching system to display that selected followed user's blog news in the followed category as described in reference to FIG. 11.

It can be appreciated that the disclosure provided herein provides for a method and system for matching two or more users with one another in accordance with preference and location data associated with each of the multitude of users. Further, the disclosure provides for a transaction and matching system that presents a suggested transaction to the matched users in accordance with the preference and location data. The preference and location data may be stored within a user database associated with the multitude of users. The suggested transaction may include a suggested transaction for a product and/or activity based at least in part on the preference and location data. In some embodiments, the transaction may include an online purchase suggested automatically by the transaction and matching system. In some embodiments, the transaction may include an activity suggested automatically by the transaction and matching system.

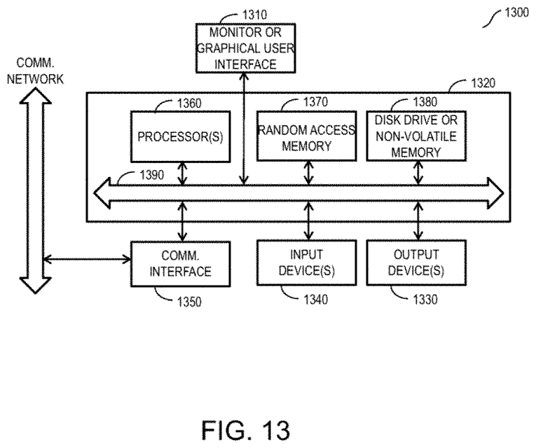

FIG. 13 depicts a simplified block diagram of a computer system that may incorporate embodiments of the present invention. FIG. 13 is merely illustrative of an embodiment incorporating the present invention and does not limit the scope of the invention as recited in the claims. One of ordinary skill in the art would recognize other variations, modifications, and alternatives.

In some embodiments, computer system 1300 typically includes a monitor or 1310, a computer 1320, user output devices 1330, user input devices 1340, communications interface 1350, and the like. Computer system 1300 may also be a smart phone, tablet-computing device, and the like, such that the boundary of computer 1320 may enclose monitor or graphical user interface 1310, user output devices 1330, user input devices 1340, and/or communications interface 1350 (not shown).

As depicted in FIG. 13, computer 1320 may include a processor(s) 1360 that communicates with a number of peripheral devices via a bus subsystem 1390. These peripheral devices may include user output devices 1330, user input devices 1340, communications interface 1350, and a storage subsystem, such as random access memory (RAM) 1370 and disk drive or non-volatile memory 1380.

User input devices 1330 include all possible types of devices and mechanisms for inputting information to computer system 1320. These may include a keyboard, a keypad, a touch screen incorporated into the display, audio input devices such as voice recognition systems, microphones, and other types of input devices. In various embodiments, user input devices 1330 are typically embodied as a computer mouse, a trackball, a track pad, a joystick, wireless remote, drawing tablet, voice command system, eye tracking system, and the like. User input devices 1330 typically allow a user to select objects, icons, text and the like that appear on the monitor or graphical user interface 1310 via a command such as a click of a virtual button, touch of the display screen, or the like.

User output devices 1340 include all possible types of devices and mechanisms for outputting information from computer 1320. These may include a display (e.g., monitor or graphical user interface 1310), non-visual displays such as audio output devices, etc.

Communications interface 1350 provides an interface to other communication networks and devices. Communications interface 1350 may serve as an interface for receiving data from and transmitting data to other systems. Embodiments of communications interface 1350 typically include an Ethernet card, a modem (telephone, satellite, cable, ISDN), (asynchronous) digital subscriber line (DSL) unit, FireWire interface, USB interface, and the like. For example, communications interface 1350 may be coupled to a computer network, to a FireWire bus, or the like. In other embodiments, communications interfaces 1350 may be physically integrated on the motherboard of computer 1320, and may be a software program, such as soft DSL, or the like. Embodiments of communications interface 1350 may also include a wireless radio transceiver using radio transmission protocols such as Bluetooth®, WiFi®, cellular, and the like.

In various embodiments, computer system 1300 may also include software that enables communications over a network such as the HTTP, TCP/IP, RTP/RTSP protocols, and the like. In alternative embodiments of the present invention, other communications software and transfer protocols may also be used, for example IPX, UDP or the like.

In some embodiment, computer 1320 includes one or more Xeon microprocessors from Intel as processor(s) 1360. Further, one embodiment, computer 1320 includes a UNIX-based operating system. In another embodiment, the processor may be included in an applications processor or part of a system on a chip.

RAM 1370 and disk drive or non-volatile memory 1380 are examples of tangible media configured to store data such as embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), battery-backed volatile memories, networked storage devices, and the like. RAM 1370 and disk drive or non-volatile memory 1380 may be configured to store the basic programming and data constructs that provide the functionality of the present invention.

Software code modules and instructions that provide the functionality of the present invention may be stored in RAM 1370 and disk drive or non-volatile memory 1380. These software modules may be executed by processor(s) 1360. RAM 1370 and disk drive or non-volatile memory 1380 may also provide a repository for storing data used in accordance with the present invention.

RAM 1370 and disk drive or non-volatile memory 1380 may include a number of memories including a main random access memory (RAM) for storage of instructions and data during program execution and a read only memory (ROM) in which fixed instructions are stored. RAM 1370 and disk drive or non-volatile memory 1380 may include a file storage subsystem providing persistent (non-volatile) storage for program and data files. RAM 1370 and disk drive or non-volatile memory 1380 may also include removable storage systems, such as removable flash memory.

Bus subsystem 1390 provides a mechanism for letting the various components and subsystems of computer 1320 communicate with each other as intended. Although bus subsystem 1390 is shown schematically as a single bus, alternative embodiments of the bus subsystem may utilize multiple busses.

FIG. 13 is representative of a computer system capable of embodying a portion of the present invention. It will be readily apparent to one of ordinary skill in the art that many other hardware and software configurations are suitable for use with the present invention. For example, the computer may be a desktop, laptop, portable, rack-mounted, smart phone or tablet configuration. Additionally, the computer may be a series of networked computers. Further, the use of other microprocessors are contemplated, such as Pentium™ or Itanium™ microprocessors; Opteron™ or AthlonXP™ microprocessors from Advanced Micro Devices, Inc; embedded processors such as ARM® licensed from ARM® Holdings plc., and the like. Further, other types of operating systems are contemplated, such as Windows®, WindowsXP®, WindowsNT®, WindowsRT® or the like from Microsoft Corporation, Solaris from Sun Microsystems, LINUX, UNIX, or mobile operating systems such as Android® from Google Inc., iOS® from Apple Inc., Symbion® from Nokia Corp., and the like. In still other embodiments, the techniques described above may be implemented upon a chip or an auxiliary processing board.

Various embodiments of the present invention can be implemented in the form of logic in software or hardware or a combination of both. The logic may be stored in a computer readable or machine-readable non-transitory storage medium as a set of instructions adapted to direct a processor of a computer system to perform a set of steps disclosed in embodiments of the present invention. The logic may form part of a computer program product adapted to direct an information-processing device to perform a set of steps disclosed in embodiments of the present invention. Based on the disclosure and teachings provided herein, a person of ordinary skill in the art will appreciate other ways and/or methods to implement the present invention.

The above embodiments of the present invention are illustrative and not limiting. The above embodiments of the present invention may be combined, in one or multiple combinations, as various alternatives and equivalents are possible. Although, the invention has been described with reference to a wearable-computing device such as a pair of eyeglasses by way of an example, it is understood that the invention is not limited by the type of wearable device. Although, the invention has been described with reference to certain radio communications interface by way of an example, it is understood that the invention is not limited by the type of radio, wireless, or wired communications interface. Although, the invention has been described with reference to a certain smart-phone manufacturer by way of an example, it is understood that the invention is not limited by the type of smart-phone manufacturer. Although, the invention has been described with reference to certain operating systems by way of an example, it is understood that the invention is not limited by the type of operating systems. Other additions, subtractions, or modifications are obvious in view of the present disclosure and are intended to fall within the scope of the appended claims.

What is claimed is:

1. A method, comprising:
determining a location of a first user and a second user;
receiving supplemental data associated the first user and supplemental data associated with the second user;
determining a match between a first user and a second user based at least in part on the determined location and the supplemental data;
presenting a transaction to at least one of the first user or the second user based at least in part on the determined location and the supplemental data; and
facilitating a payment from at least one of the first user or the second user for the transaction.

2. The method of claim 1, further comprising transmitting a transaction receipt for the transaction to at least one of the first user or the second user.

3. The method of claim 1, wherein the supplemental data is received from a social network.

4. The method of claim 1, wherein determining the location of the first user and the second user comprises determining a location of a first portable computing device associated with the first user and a second portable computing device associated with the second user.

5. The method of claim 1, wherein facilitating the payment from at least one of the first user or the second comprises proportionally dividing a total transaction amount for the transaction into a first transaction amount and a second transaction amount, and facilitating a payment for the first transaction amount from the first user and a payment for the second transaction amount from the second user.

6. The method of claim 1, wherein the supplemental data comprises at least one of user biological data, user social data, user education data, user ethnicity data, user interest data, user relationship data, user religion data, user political data, or user skill data.

7. The method of claim 1, further comprising:
presenting, via a user interface to the first user, the supplemental data associated with the second user; and
presenting, via the user interface to the second user, the supplemental data associated with the first user.

8. The method of claim 1, further comprising updating a user database based at least in part on completion of the transaction.

9. The method of claim 1, wherein determining the match between the first user and the second user is based at least in part on a match score, wherein the match score is determined based at least in part on a correlation between the supplemental data associated the first user and the supplemental data associated with the second user.

10. A server computer comprising a processor, and a computer readable medium coupled the processor, the computer readable medium comprising code, executable by the processor, for implementing a method comprising:
determining a location of a first user and a second user;
receiving supplemental data associated the first user and supplemental data associated with the second user;
determining a match between a first user and a second user based at least in part on the determined location and the supplemental data;
presenting a transaction to at least one of the first user or the second user based at least in part on the determined location and the supplemental data; and
facilitating a payment from at least one of the first user or the second user for the transaction.

11. The server computer of claim 10, wherein the method further comprises transmitting a transaction receipt for the transaction to at least one of the first user or the second user.

12. The server computer of claim 10, wherein the supplemental data is received from a social network.

13. The server computer of claim 10, wherein determining the location of the first user and the second user comprises determining a location of a first portable computing device associated with the first user and a second portable computing device associated with the second user.

14. The server computer of claim 10, wherein facilitating the payment from at least one of the first user or the second comprises proportionally dividing a total transaction amount for the transaction into a first transaction amount and a second transaction amount, and facilitating a payment for the first transaction amount from the first user and a payment for the second transaction amount from the second user.

15. The server computer of claim 10, wherein the supplemental data comprises at least one of user biological data, user social data, user education data, user ethnicity data, user interest data, user relationship data, user religion data, user political data, or user skill data.

16. The server computer of claim 10, wherein the method further comprises:
presenting, via a user interface to the first user, the supplemental data associated with the second user; and
presenting, via the user interface to the second user, the supplemental data associated with the first user.

17. The server computer of claim 10, wherein the method further comprises updating a user database based at least in part on completion of the transaction.

18. The server computer of claim 10, wherein determining the match between the first user and the second user is based at least in part on a match score, wherein the match score is determined based at least in part on a correlation between the supplemental data associated the first user and the supplemental data associated with the second user.

19. One or more non-transitory computer-readable media storing computer-executable instructions that, when executed, cause one or more computing devices included in a portable computing device to:
determine a location of a first user and a second user;
receive supplemental data associated the first user and supplemental data associated with the second user;
determine a match between a first user and a second user based at least in part on the determined location and the supplemental data;
present a transaction to at least one of the first user or the second user based at least in part on the determined location and the supplemental data; and
facilitate a payment from at least one of the first user or the second user for the transaction.

20. The one or more non-transitory computer-readable media of claim 19, further comprising computer-executable instructions that, when executed, cause the one or more computing devices included in the portable computing device to transmit a transaction receipt for the transaction to at least one of the first user or the second user.

21. The one or more non-transitory computer-readable media of claim 19, wherein the supplemental data is received from a social network.

22. The one or more non-transitory computer-readable media of claim 19, wherein determining the location of the first user and the second user comprises determining a location of a first portable computing device associated with the first user and a second portable computing device associated with the second user.

23. The one or more non-transitory computer-readable media of claim 19, wherein facilitating the payment from at least one of the first user or the second comprises proportionally dividing a total transaction amount for the transaction into a first transaction amount and a second transaction amount, and facilitating a payment for the first transaction amount from the first user and a payment for the second transaction amount from the second user.

24. The one or more non-transitory computer-readable media of claim 19, wherein the supplemental data comprises at least one of user biological data, user social data, user education data, user ethnicity data, user interest data, user relationship data, user religion data, user political data, or user skill data.

25. The one or more non-transitory computer-readable media of claim 19, further comprising computer-executable instructions that, when executed, cause the one or more computing devices included in the portable computing device to:
present, via a user interface to the first user, the supplemental data associated with the second user; and
present, via the user interface to the second user, the supplemental data associated with the first user.

26. The one or more non-transitory computer-readable media of claim 19, further comprising computer-executable instructions that, when executed, cause the one or more computing devices included in the portable computing device to update a user database based at least in part on completion of the transaction.

27. The one or more non-transitory computer-readable media of claim 19, wherein determining the match between the first user and the second user is based at least in part on a match score, wherein the match score is determined based at least in part on a correlation between the supplemental data associated the first user and the supplemental data associated with the second user.
